(19) United States
(12) Patent Application Publication
(10) Pub. No.: US 2026/0110315 A1
(43) Pub. Date: Apr. 23, 2026

(54) FOUR-BAR LATCH ASSEMBLY

(71) Applicant: BLUE ORIGIN MANUFACTURING, LLC, Huntsville, AL (US)

(72) Inventors: Christopher Benjamin Nolker, Cocoa Beach, FL (US); Krystof Peter Jankowski, Waterford, MI (US); Ruth Chelsea Wehby, Nashville, TN (US)

(21) Appl. No.: 19/367,440

(22) Filed: Oct. 23, 2025

Related U.S. Application Data
(60) Provisional application No. 63/711,113, filed on Oct. 23, 2024.

(51) Int. Cl. F16B 1/00

(52) U.S. Cl. CPC F16B 1/00

(57) ABSTRACT

The present disclosure is directed to a four-bar assembly for use in various circumstances such as docking, coupling, or capture operations. The four-bar assembly may include an upper link, a middle link, and a lower link connected to form a four-bar linkage. The middle link may serve as an active latching element for engaging a latch feature on a mating structure. A cam or slider may control the potential range of motion of the lower link, allowing the middle link to move between a retracted and an engaged position to effect capture, and a second range of motion to then allow the middle link to move between an engaged and released position to effect release. In some embodiments, the four-bar assembly includes contingency mechanisms such as hold-down and release devices (HDRMs), a contingency lever, or dual-surface cams configured to selectively disable or isolate motion of the latching components during overload or fault conditions.

### INCORPORATION BY REFERENCE TO RELATED APPLICATION(S)

Any and all applications for which a foreign or domestic priority claim is identified in the Application Data Sheet as filed with the present application are hereby incorporated by reference under 37 CFR 1.57. For example, this is a non-provisional application that is related to and that claims the benefit of priority from U.S. Patent Application No. 63/711,113, filed on Oct. 23, 2024, entitled “CAPTURE LATCHES”. The entire contents of the application is incorporated by reference herein and form a part of this specification for all purposes.

### GOVERNMENT LICENSE RIGHTS

This invention was made with government support under NASA SLD 80MSFC23CA014 awarded by the National Aeronautics and Space Administration (NASA). The government has certain rights in the invention.

### TECHNICAL FIELD

This disclosure relates to four-bar linkage assemblies for latching, capturing, and releasing mating structures.

### BACKGROUND

Some existing docking and latching mechanisms, including those developed for the Apollo missions, often rely on spider-type or probe-and-drogue assemblies. These mechanisms employ a series of outer latch arms or petals positioned along the periphery of a docking structure to capture and secure a corresponding ring or receptacle on a mating vehicle. While these designs may be effective in some circumstances, they are mechanically complex in ways that may bring unnecessary fault scenarios.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIGS. 1A-1C illustrate a conventional latching mechanism involving a capture link as a lower link in a four-bar assembly, according to example embodiments;

FIGS. 2A-2D illustrate a four-bar assembly including an upper link, middle link, lower link, and cam, and further including a contingency system, wherein the middle link acts as a capture latch, and wherein the contingency mechanism may be activated to remove the middle link from any latching action, according to example embodiments;

FIGS. 3A-3E illustrate a four-bar assembly including an upper link, middle link, and lower link, and a slider to move in a slot, in which the movement of the slider allows a link in the four-bar assembly to have a range of motion allowing the middle link to be moved out of contact with a latch or connecting surface, according to example embodiments;

FIGS. 4A-4B illustrate a four-bar assembly including an upper link, middle link, and lower link, and a cam to operate the four-bar assembly, according to example embodiments;

FIGS. 5A-5B illustrate a four-bar assembly including an upper link, middle link, and lower link, and a cam to operate the four-bar assembly, the cam having a first cam surface and a second cam surface, wherein the lower link and the cam can be forced to move such that the lower link moves from one cam surface to the other, according to example embodiments;

FIG. 6A illustrates a four-bar assembly including an upper link, middle link, and lower link, and a cam to operate the four-bar assembly, and further including an upper link slot operably connected to an end of the upper link, wherein a contingency mechanism, keeps the upper link at a desired location within the upper link slot for nominal latch operation, according to example embodiments;

FIGS. 6B and 6C illustrate a four-bar assembly including an upper link, middle link, and lower link, and a cam to operate the four-bar assembly, and further including a contingency mechanism operably attached to the cam via a contingency link and a cam link, according to example embodiments;

FIGS. 7A and 7B illustrate a contingency mechanism in a four-bar assembly including a slider which can be split into two halves by the activation of a contingency mechanism, according to example embodiments;

FIG. 7C illustrates the relationship between the coefficient of friction and maximum angle of the lower link and the slider interface to prevent jamming, according to example embodiments;

FIG. 7D illustrates the various forces acting on the lower link when engaging with the split-slider, according to example embodiments;

FIGS. 8A and 8B illustrate a four-bar assembly including an upper link, middle link, and lower link, further including a contingency lever connecting a contingency link to the upper link, wherein the activation of the contingency link causes the contingency lever to swing freely, and thereby causes the middle link to move out of contact with a captured surface or object, according to example embodiments;

FIGS. 9A and 9B illustrate a four-bar assembly including an upper link, middle link, and lower link, wherein the lower link includes a lower link hook for operably contacting a slider, wherein when the slider is actuated into a position where it is able to make full contact with the hook, all degrees of freedom of the lower link are locked, preventing the system from rattling excessively in a high vibration environment, partial retraction of the slider from the hook allows for nominal operation of the four-bar linkage, and full retraction allows the lower link to operate in a degree of freedom which allows the middle link to move out of a contact with a captured surface or object, according to example embodiments;

FIG. 10 illustrates a process for actuating a middle link in a four-bar assembly using a cam, according to example embodiments; and

FIG. 11 illustrates a process for actuating a middle link in a four-bar assembly using a cam or slider, according to example embodiments.

### SUMMARY OF THE DISCLOSURE

In example embodiments, the present disclosure provides a four-bar assembly comprising an upper link and a middle link operably connected to the upper link. The middle link may engage a mating structure. The four-bar assembly also includes a lower link operably connected to the middle link, and a cam to drive the lower link through a first range of motion. The first range of motion of the lower link drives the middle link between a retracted position and an engaged position relative to the mating structure.

In further example embodiments, a method comprises rotating a cam to drive a lower link, in a four-bar assembly, through a first range of motion. The method further includes driving, by the lower link, a middle link from a retracted position to an engaged position. The method further includes engaging the middle link with a mating structure and releasing the middle link from the mating structure by rotating the cam to drive the middle link to the released position.

In still further example embodiments, a four-bar docking assembly may include an upper link and a middle link. The middle link may latch onto a mating structure. The four-bar docking assembly may further include a lower link, a slider to drive the lower link through a first range of motion and a second range of motion. The four-bar docking assembly may also include a contingency element to disable the middle link under one or more contingency conditions. The first range of motion of the lower link may drive the middle link between a retracted position and an engaged position relative to the mating structure, and the second range of motion of the lower link drives the middle link between an engaged position and a released position relative to the mating structure.

### DETAILED DESCRIPTION

The present disclosure provides a four-bar assembly that may improve the reliability and mechanical efficiency of latching operations. In example embodiments, the assembly may include an upper link, a middle link, and a lower link, connected to form a closed four-bar linkage. The middle link may serve as the active latching element. The middle link may include a roller at its distal end to facilitate smooth engagement with a target latch surface or mating feature. The lower link may be mechanically coupled to a cam, such that rotation of the cam drives the lower link through one or more positions, e.g., corresponding to a recessed (safe) position, an extended (released) position, and a middle (standby) position.

In example embodiments, rotation of the cam causes the lower link to move the middle link in a controlled path, allowing the middle link to engage or disengage from a mating structure with minimal friction. In some example embodiments, redundant or contingency mechanisms—such as hold-down and release devices (HDRMs), frangible bolts, or cam-surface overrides—may be included to mechanically isolate the middle link in the event of a fault. The resulting assembly provides a simplified, latching mechanism that has less potential fault scenarios.

In many previous four-bar or latch-arm assemblies, the motion path of the capture element or capture latch followed a substantially circular trajectory, such that the motion used to capture a mating surface was identical to the motion used to release it. While mechanically simple, this configuration often resulted in geometric overlap between the capture and release paths, increasing the likelihood of interference, incomplete retraction, or jamming of the latch. The identical motion arcs also made it difficult to apply differential forces during engagement and disengagement, since both operations occurred along the same line of travel.

In contrast, the present disclosure provides a four-bar assembly in which the middle link follows distinct motion profiles for engagement and release. In example embodiments, the capture path occurs along a first trajectory (or first motion profile, first motion path, first degree of freedom, etc.), and the release path follows a second, separate trajectory or degree of freedom. Furthermore, some embodiments allow the middle link to move in a third trajectory responsive to an activation of a contingency mechanism. This separation of motion ranges enables smoother retraction, greater tolerance for misalignment, and the ability to apply non-symmetric force vectors during the two operations. Accordingly, the middle link does not operate in a purely circular fashion but rather through a controlled compound motion, thereby allowing the assembly to capture, hold, and release mating structures with higher precision and reduced mechanical error across a variety of docking and coupling environments.

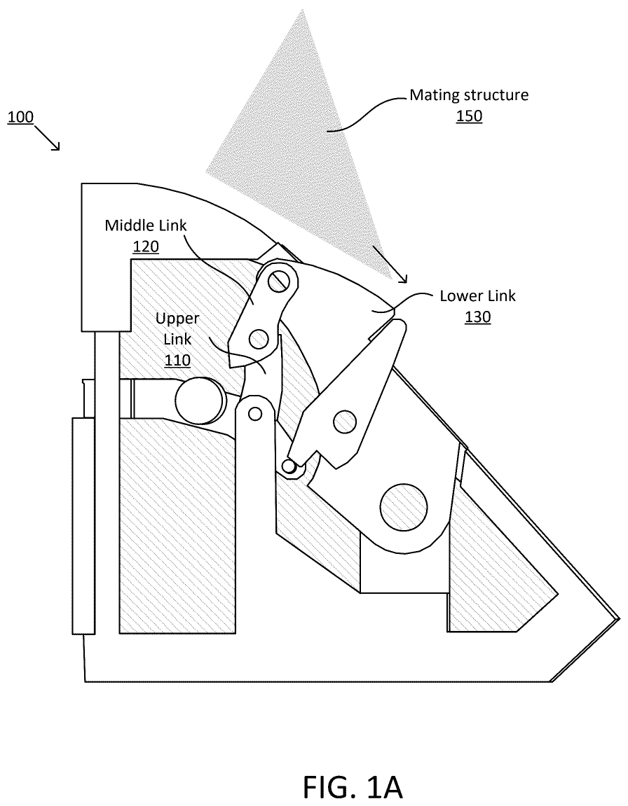

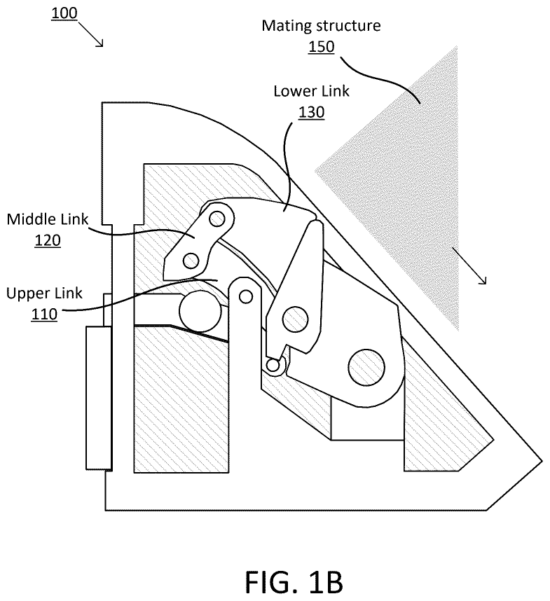

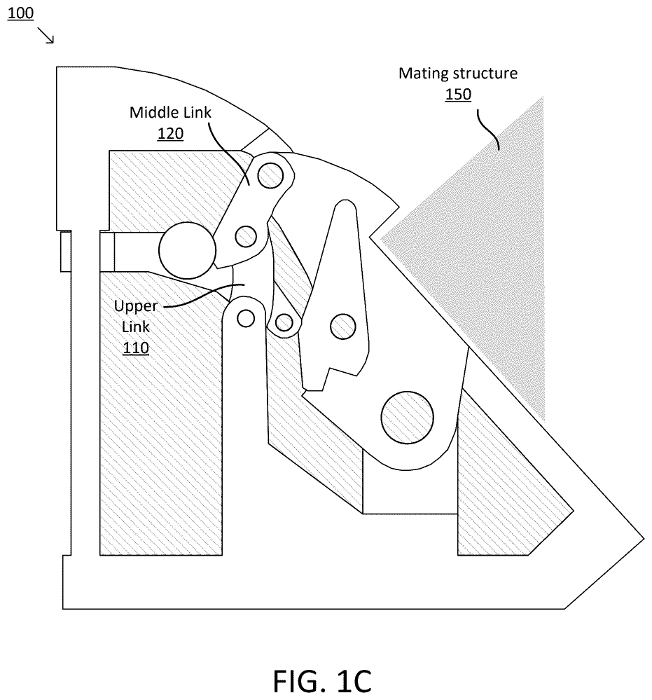

FIGS. 1A, 1B, and 1C illustrate a conventional four-bar assembly 100 of the type historically employed in spider-style or probe-and-drogue mechanisms. The four-bar assembly 100 generally includes an upper link 110, a middle link 120, and a lower link 130, each of which is pivotally connected to form a multi-link structure such as a four-bar assembly, wherein the lower link 130 is the capture element or capture latch. The four-bar assembly 100 may be mounted to a fixed frame or housing that forms part of, e.g., a spacecraft docking interface.

As illustrated in FIG. 1A, the four-bar assembly 100 is in a neutral or rest position prior to being pressed by a mating structure 150. The lower link 130 may extend or protrude from the housing of the four-bar assembly 100 and be ready to receive a lateral force to enable the lower link 130 to be pressed inward into the four-bar assembly 100 housing.

As illustrated in FIG. 1B, the four-bar assembly 100 is depicted as reacting to being pressed (e.g., engaging a lateral force) from a mating structure 150, prior to engagement with a mating structure 150. When the mating structure 150 applies force to the lower link 130, the lower link 130 is oriented such that its distal end is positioned inwardly toward the structure, while the trigger rests in a waiting position, holding the spider down so the upper link 110 and middle link 120 may pivot backwards to allow for capture. In this condition, the four-bar assembly 100 is prepared to approach a mating component but has not yet engaged a target surface or mating structure 150.

As illustrated in FIG. 1C, the four-bar assembly 100 transitions into a capture or engaged position, wherein the lower link 130 pivots outward to contact and secure a latch material or edge on the mating structure 150. As the lower link 130 moves to engage a mating structure 150, the trigger is depressed, allowing the spider to travel upwards behind the upper link 110 and middle link 120, effectively preventing subsequent motion (i.e., retraction of the latch). As illustrated, the lower link 130 may serve as the active capture element, being spring-driven to engage the mating structure 150. The upper link 110 and middle link 120 provide mechanical support, locking the lower link 130 in its latched position.

Although this configuration provides a workable mechanical linkage for capture and docking, it presents some limitations. The lower link 130 may perform the same range of motion for both capture and release motions, such that the motion used to capture a mating structure 150 was identical to the motion used to release it. This motion of the lower link 130 may increase the likelihood of interference, incomplete retraction, or jamming of the lower link 130 or other components of the four-bar assembly 100. The identical motion arcs also may cause difficulty in applying differential forces during engagement and disengagement, since both operations occur along the same line of travel. Accordingly, while the four-bar assembly 100 illustrated in FIGS. 1A and 1B provide a representative example of conventional docking mechanisms, they also illustrate the inherent drawbacks of relying on additional locking features.

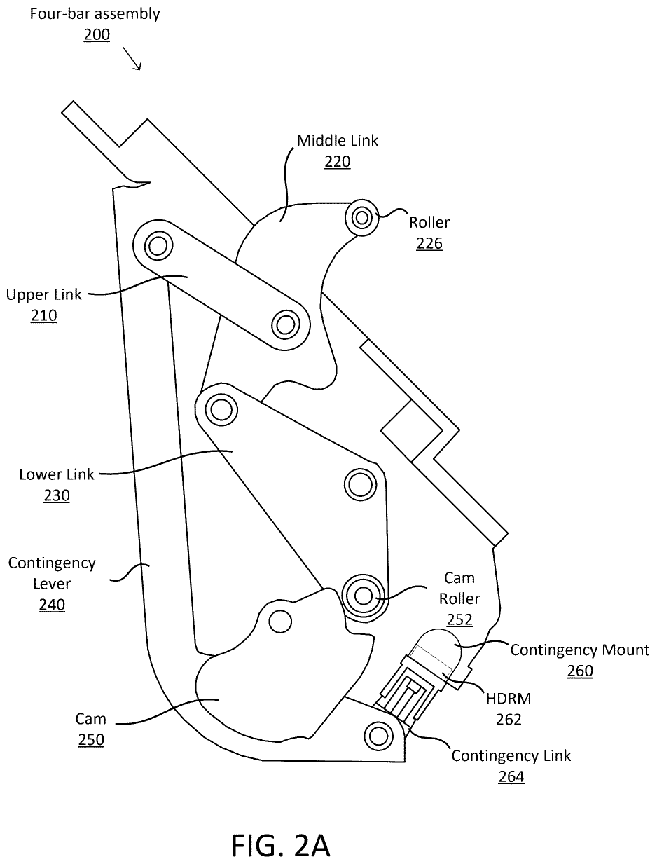

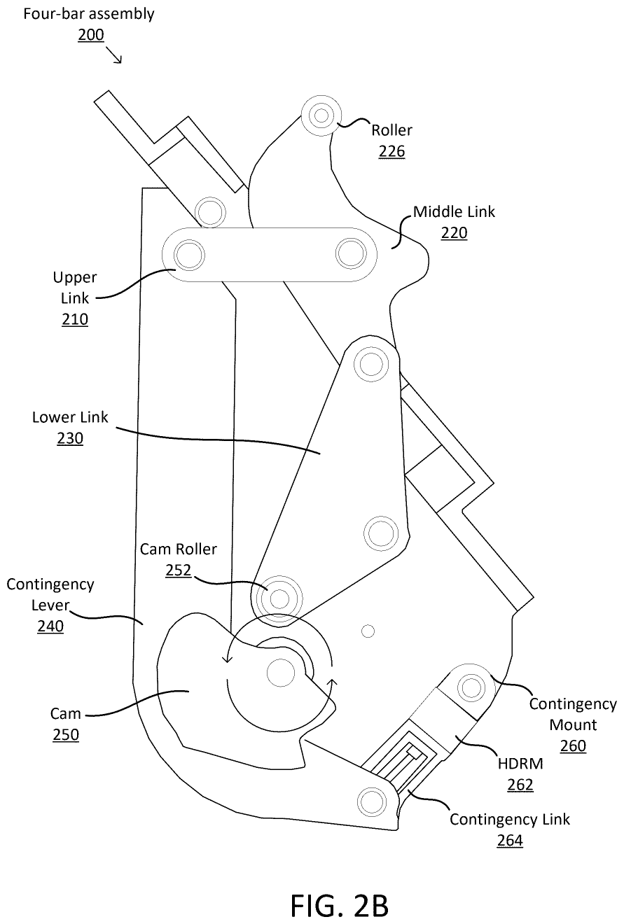

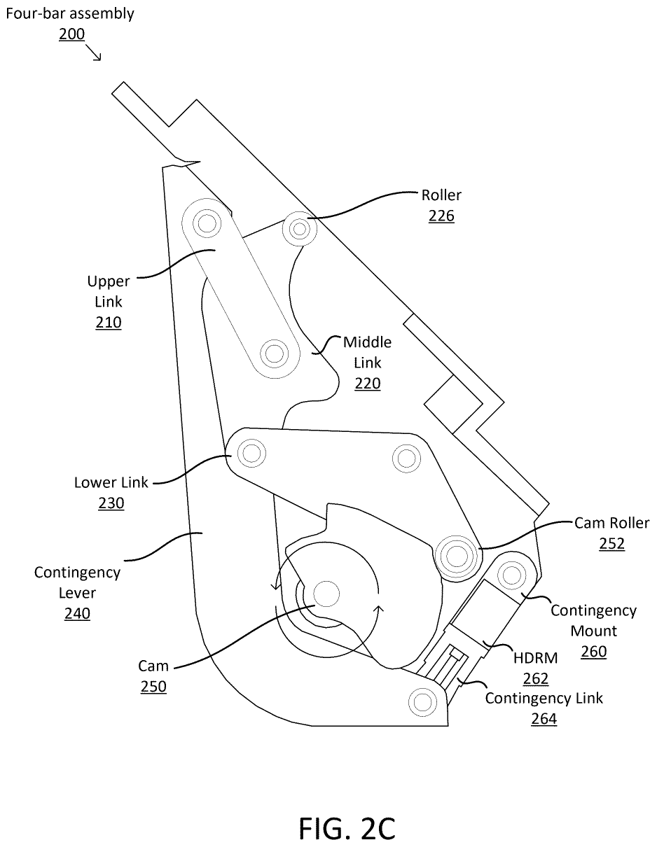

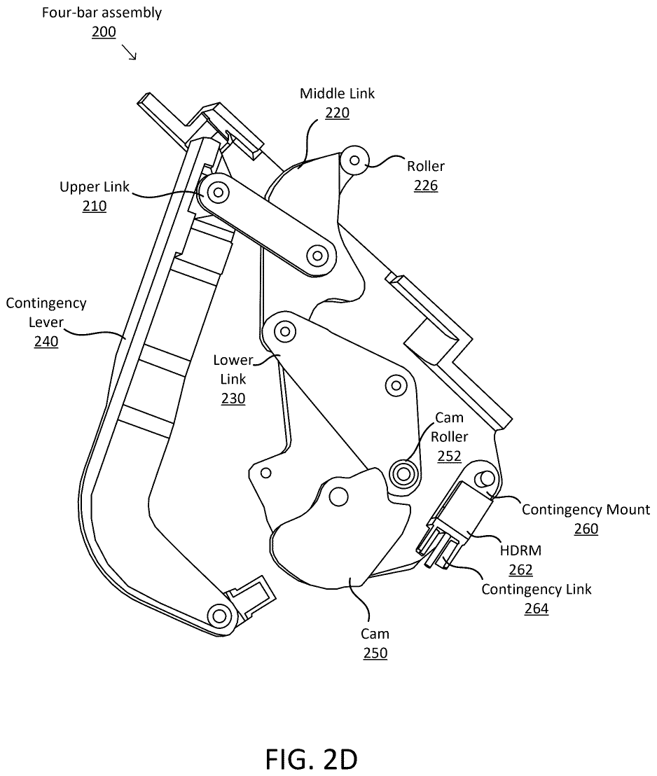

FIGS. 2A-2D illustrate example embodiments of a four-bar assembly 200 for use in various environments including, without limitation, vehicle docking environments. The four-bar assembly 200 may include an upper link 210, a middle link 220, a lower link 230, and a cam 250, which together define a controlled four-bar motion profile. The upper link 210 may be pivotally connected at one end to the middle link 220 and at its opposite end to a contingency lever 240. The contingency lever 240, in turn, may interface with a contingency link 264, which may be selectively actuated by a hold-down and release mechanism (HDRM) 262 mounted to a contingency mount 260 affixed to the surrounding housing. The HDRM 262 may provide an emergency means to release a hold on the contingency lever 240, allowing it to pivot out, pulling on the upper link 210 and thereby retracting the middle link 220 to allow for releasing a mating surface in the event of a fault or obstruction.

The middle link 220 may serve as the active latching element of the four-bar assembly 200. One end of the middle link 220 may be coupled to the upper link 210, and the opposite end may be coupled to the lower link 230. The distal portion of the middle link 220 may terminate in a roller 226. The roller 226 may allow the middle link 220 to roll smoothly along a mating latch surface, edge, or receptacle on the opposing docking structure, thereby minimizing friction and reducing the likelihood of jamming. The middle link 220 may be arranged such that it may move both inwardly and outwardly relative to the housing of the four-bar assembly 200, transitioning between, e.g., a retracted safe state, a middle standby/captured state, and an extended released state.

The lower link 230 may be mechanically coupled at one end to the middle link 220 and at its opposite end terminate at a cam roller 252 that interfaces with the cam 250. In example embodiments, as the cam 250 rotates about its axis, the cam 250 may drive the cam roller 252, causing the lower link 230 to pivot through a controlled angular displacement. This motion of the lower link 230 may propagate through the four-bar geometry to precisely control the position of the middle link 220. The configuration allows the entire latching sequence—standby/capture, release, and retraction—to be commanded through a single rotary input to the cam 250.

In some example embodiments of the assembly 200 shown in FIGS. 2A-2D, a torsion spring or other biasing element may be operably coupled to the lower link 230 to provide a predetermined rotational bias. As a nonlimiting example, the spring may be mounted concentrically about the pivot axis of the lower link 230 or anchored between the lower link 230 and the surrounding housing. In example embodiments, the spring may be configured to bias the lower link 230 in either a clockwise or counterclockwise direction, depending on the desired operational behavior. In some example embodiments, the cam 250 may operate in coordination with the spring bias to assist or resist rotation of the lower link 230, thereby defining stable intermediate positions such as a retracted position, a standby or ready-to-capture position, and a release position. In other example embodiments, multiple torsion springs or equivalent elastic biasing members (such as flexures, leaf springs, or pre-loaded compression elements) may be used to fine-tune the responsiveness of the four-bar assembly 200 during both manual and automated docking operations.

FIG. 2A depicts the four-bar assembly 200 in a capture-ready configuration and/or standby configuration. In this position, the cam 250 is oriented such that the lower link 230 positions the middle link 220 outwardly, with a roller 226 extending beyond the housing. The roller 226 may roll along a mating surface as the four-bar assembly 200 approaches a target edge or latch material. This orientation facilitates positive engagement between the middle link 220 and the corresponding latch feature during docking.

FIG. 2B illustrates the four-bar assembly 200 in a release configuration. Here, rotation of the cam 250 in the designated direction causes the cam roller 252 to roll off the cam 250 profile, allowing the lower link 230 to pivot in a clockwise direction from the side shown, driven by a spring (not illustrated), and thereby extending the middle link 220 upwards and backwards. The middle link 220 and roller 226 are thus withdrawn from the mating structure, disengaging the latch and allowing the docking interface to separate.

FIG. 2C shows the four-bar assembly 200 in a fully retracted or stowed configuration, in which the middle link 220 is positioned completely within the housing of the four-bar assembly 200. This state may be used when the four-bar assembly 200 is inactive, during transport, or in high vibrational environments such as launch, or when avoiding accidental contact with external surfaces. The cam 250 may be rotated such that the cam roller 252 drives the lower link 230 to an inward angle, thereby drawing the middle link 220 and roller 226 clear of any engagement path. As illustrated, the middle link 220 follows distinct motion profiles for engagement and release. In example embodiments, the capture path occurs along a first trajectory (or first motion profile, first motion path, first degree of freedom, etc.), and the release path follows a second, separate trajectory or degree of freedom. Accordingly, the middle link 220 does not operate in a purely circular fashion but rather through a controlled compound motion. In some example embodiments, the cam 250 may comprise an additional profile on the surface of the cam 250, such that the cam 250, upon rotating a certain amount, may drive the lower link 230 to a position that disables all motion within the four-bar assembly 200.

FIG. 2D illustrates the four-bar assembly 200 under a contingency or emergency condition. In this state, the HDRM 262 has been activated, releasing or severing the contingency link 264. Once released, the contingency lever 240 is free to rotate about its pivot, pulling on the upper link 210. This motion may allow the middle link 220 to pivot into a position that removes the middle link 220 from contact with the mating structure. This contingency action may prevent the four-bar assembly 200 from jamming or applying unintended forces if foreign material, misalignment, or mechanical failure is detected. During normal operation, the contingency link 264 remains intact, holding the contingency lever 240 and upper link 210 in fixed relation. In this state, the four-bar assembly 200 is rigidly maintained, and rotation of the lower link 230 drives the middle link 220 between its capture and release positions.

Through the cooperation of the cam-driven lower link 230, the middle link 220, and the HDRM-based contingency link 264, the four-bar assembly 200 provides both precise latching control and robust capability. The four-bar motion of the four-bar assembly 200 yields a predictable trajectory for the middle link 220, while the contingency mechanisms (the HDRM 262 and the contingency link 264) ensure that the four-bar assembly 200 may be safely released when abnormal conditions occur.

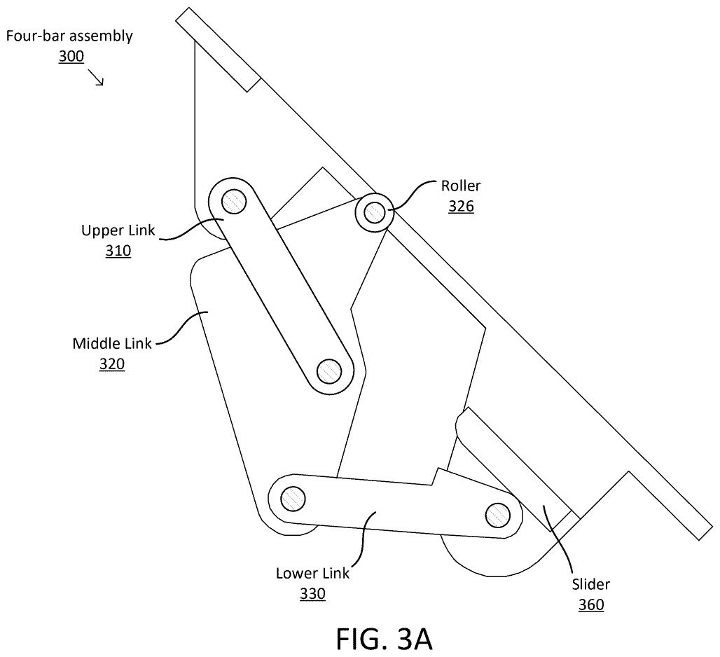

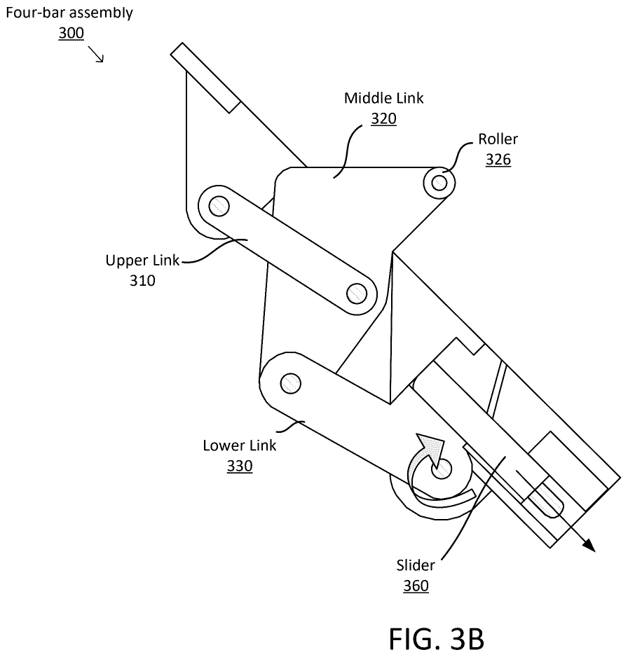

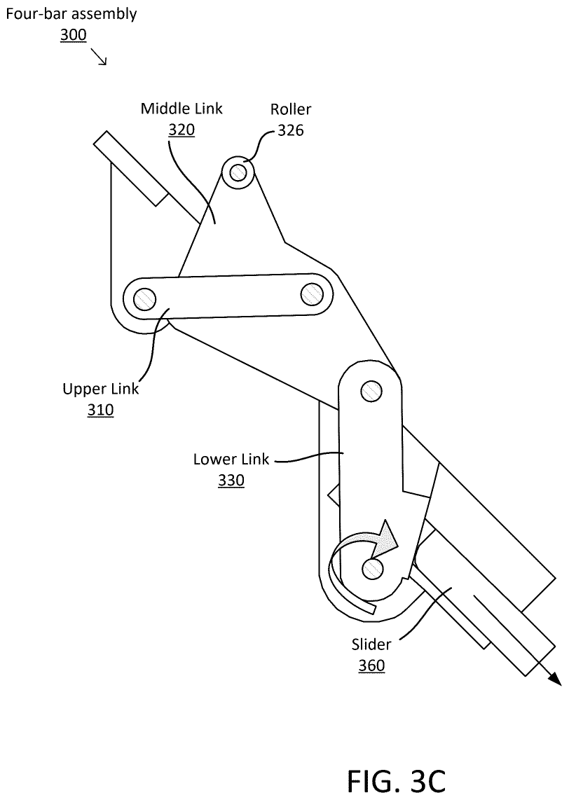

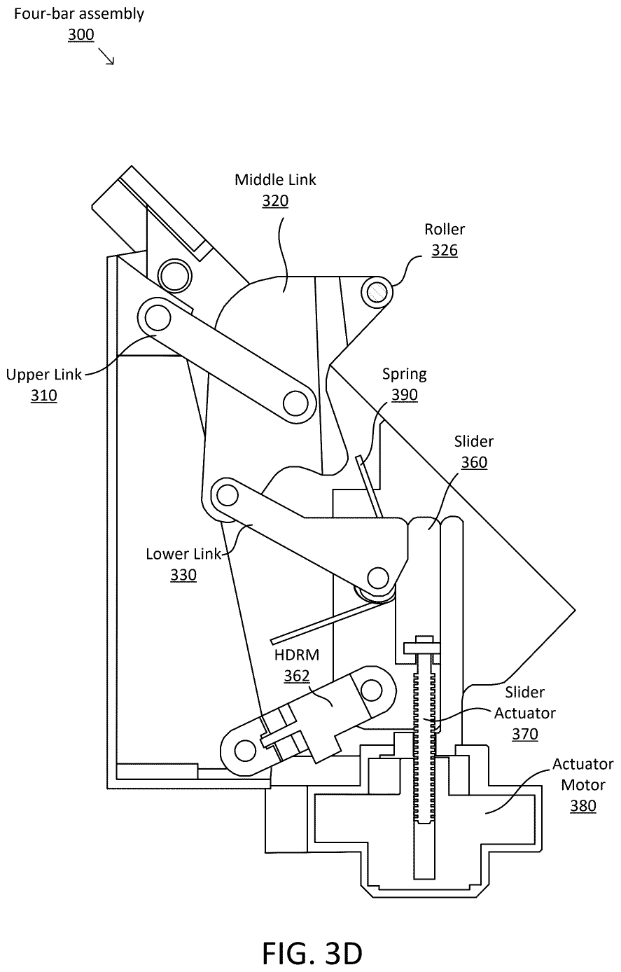

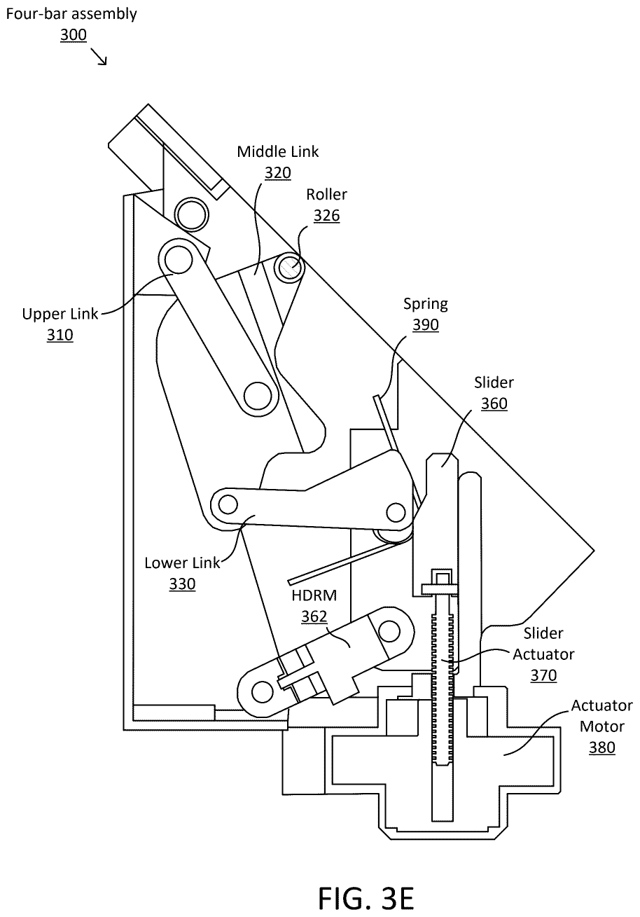

FIGS. 3A-3C illustrate example embodiments of a four-bar assembly 300, configured for actuation via a linear slider 360 rather than a cam. The four-bar assembly 300 may include an upper link 310, a middle link 320, and a lower link 330, each pivotally interconnected to form a four-bar linkage. Similar to other example embodiments described elsewhere herein, the middle link 320 may function as an active latching element of the four-bar assembly 300, while the lower link 330 is the actively controlled linkage. As described elsewhere herein, the middle link 320 may follow distinct motion profiles for engagement and release. In example embodiments, the capture path occurs along a first trajectory (or first motion profile, first motion path, first degree of freedom, etc.), and the release path follows a second, separate trajectory or degree of freedom.

The middle link 320 may include a roller 326 rotatably mounted along an outer surface and/or distal end of the middle link 320. The roller 326 may be configured to roll against a target edge, latch feature, or docking surface, thereby reducing sliding friction and wear during engagement or release. In example embodiments, the motion of the middle link 320 may define a predictable path of movement that may include extending inward to capture a target surface and/or extending outward (i.e., outward relative to the body of the four-bar assembly 300) for disengagement.

As illustrated in FIGS. 3A-3E, the lower link 330 may make mechanical contact with a slider 360, which may include a sliding contingency mechanism. In example embodiments, the slider 360 may be disposed within a socket or cavity in a surrounding housing, and the slider 360 may translate along a generally vertical or longitudinal axis corresponding to the socket or cavity. Under normal operation, the slider 360 may remain in an upper position, in which the lower link 330 is permitted to pivot through a first defined range of motion. This first range of motion may be sufficient to move the middle link 320 between its rest position and capture position, as depicted in FIGS. 3A and 3B, respectively. As illustrated, the slider 360 may be generally rectangular in shape, although in other example embodiments, it is understood that the slider 360 may comprise any suitable shape, length, or other dimensions not explicitly listed herein. Furthermore, it is understood that the slider 360 (and the corresponding socket or cavity housing the slider 360) may be disposed against either or both of the upper link 310 and the middle link 320.

In some example embodiments of the four-bar assembly 300 shown in FIGS. 3A-3E, a torsion spring or other biasing element may be operably coupled to the lower link 330 to provide a predetermined rotational bias. As a nonlimiting example, the spring may be mounted concentrically about the pivot axis of the lower link 330 or anchored between the lower link 330 and the surrounding housing. In example embodiments, the spring may be configured to bias the lower link 330 in either a clockwise or counterclockwise direction, depending on the desired operational behavior. In some example embodiments, the slider 360 may operate in coordination with the spring bias to assist or resist rotation of the lower link 330, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 300 during both manual and automated docking operations.

FIG. 3A illustrates the four-bar assembly 300 in a retracted configuration (i.e., a configuration in which the middle link 320 is positioned to not capture any ledge or latch), where the slider 360 is in its normal operating position. In example embodiments, the slider 360 may be positioned with the corresponding socket or cavity such that the lower link 330 is constrained to a controlled rotational path. In other words, the middle link 320 is in a non-latching position.

FIG. 3B illustrates the four-bar assembly 300 in a ready-to-capture configuration. In example embodiments, the lower link 330 can only rotate counterclockwise as viewed. This enables the middle link 320 to be pushed inwards by the striker during docking, and snap back to place once the striker is in place to complete capture. Even when the lower link 330 is fully rotated against the slider 360, and even when the lower link 330 is causing rotational force upon the slider 360, the slider 360 may remain stationary. Thus, the slider 360 may maintain the lower link 330's first range of motion.

FIG. 3C illustrates the four-bar assembly 300 in the released state. In such example embodiments, the slider 360 may be displaced downward within its socket, either by a manual trigger or a mechanical actuator. As the slider 360 moves downward, the slider 360 may move out of the way of the lower link 330. In other words, the slider 360 moves outside of the range of motion of the lower link 330. Thus, the lower link 330 may be allowed to move within a second range of motion, the second range of motion allowing having an increased range of motion beyond the operating envelope (e.g., envelope of freedom) of the first range of motion. This additional freedom allows the lower link 330 to pivot further inward or outward, depending on the design, which in turn forces the middle link 320 to collapse or shift into a neutral position. In example embodiments, the middle link 320 is effectively removed from contact with the mating 317 structure, thereby preventing interference or binding with external components. As illustrated in FIG. 3C, the movement of the slider 360 allows the middle link 320 to rotate counterclockwise, thereby releasing any ledge, latch, or object.

The slider 360 may thus serve as an actuator of the latch to control the state of the middle link 320. In example embodiments, the slider 360 may be positioned such that the four-bar assembly 300 may be in a standby position wherein a striker or mating surface may engage but not be released, or a retracted position that does not affect the range of motion of the lower link 330, enabling the middle link 320 to release the striker or mating surface.

FIGS. 3D and 3E illustrate an embodiment of a four-bar assembly 300 incorporating an actuator motor 380 configured to drive a slider actuator 370, which in turn translates a slider 360 that interfaces with the lower link 330. The four-bar assembly 300 also includes an upper link 310 and a middle link 320, pivotally connected to define the four-bar geometry. The middle link 320 may include a roller 326 for engaging or releasing a mating surface as described in other example embodiments discussed elsewhere herein. The four-bar assembly 300 illustrated in FIGS. 3D and 3E may further include an HDRM 362 capable of contingency operations as discussed elsewhere herein.

The actuator motor 380 may provide a source of motion for the four-bar assembly 300. In example embodiments, the actuator motor 380 may be electrically powered. The output shaft of the actuator motor 380 is mechanically coupled to the slider actuator 370, which may take the form of, without limitation, a screw, a threaded rod, or other elongated translation element. Rotation of the actuator motor 380 may convert rotary motion into linear translation of the slider actuator 370. The distal end of the slider actuator 370 may be attached to the slider 360, thereby allowing the slider 360 to move upward or downward within a guide cavity or housing channel.

As the slider 360 moves upward or downward, the slider 360 exerts a direct force on the lower link 330, which pivots about its fixed joint relative to the housing of the four-bar assembly 300. In example embodiments, an upward translation of the slider 360 may cause the lower link 330 to rotate clockwise against the bias of a spring 390, thereby extending the middle link 320 and positioning the middle link 320 outward into a capture configuration. Conversely, a downward translation of the slider 360 may allow the spring 390 to return the lower link 330 346 counterclockwise, thereby retracting the middle link 320 and withdrawing the middle link 320 into a release or standby position.

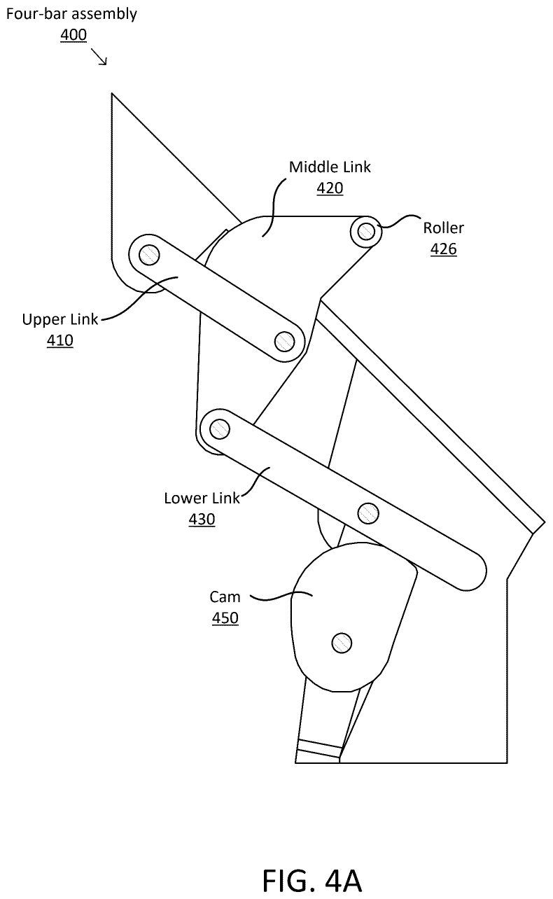

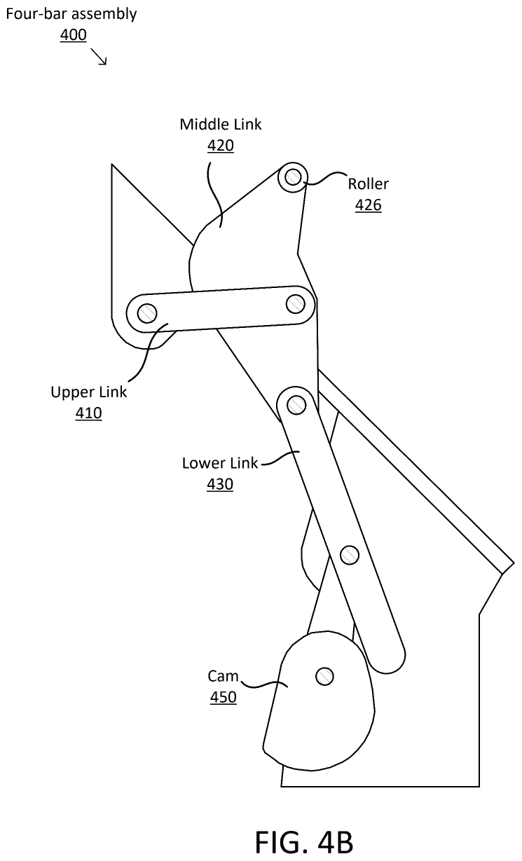

FIGS. 4A and 4B illustrate example embodiments of a four-bar assembly 400, configured to operate through direct cam actuation of the lower link. The four-bar assembly 400 may include an upper link 410, a middle link 420, and a lower link 430, all pivotally connected to define a closed four-bar linkage. The motion of the four-bar assembly 400 may be governed by a cam 450, which may engage with the lower link 430 directly rather than through a separate cam-roller interface, as illustrated in other example embodiments described elsewhere herein. As described elsewhere herein, the middle link 420 may follow distinct motion profiles for engagement and release. In example embodiments, the capture path occurs along a first trajectory (or first motion profile, first motion path, first degree of freedom, etc.), and the release path follows a second, separate trajectory or degree of freedom.

In some example embodiments of the four-bar assembly 400 shown in FIGS. 4A-4B, a torsion spring or other biasing element may be operably coupled to the lower link 430 to provide a predetermined rotational bias. As a nonlimiting example, the spring may be mounted concentrically about the pivot axis of the lower link 430 or anchored between the lower link 430 and the surrounding housing. In example embodiments, the spring may be configured to bias the 362 lower link 430 in either a clockwise or counterclockwise direction, depending on the desired operational behavior. In some example embodiments, the cam 450 may operate in coordination with the spring bias to assist or resist rotation of the lower link 430, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 400 during both manual and automated docking operations.

The middle link 420 may function as the active latching component of the four-bar assembly 400. At its distal end, the middle link 420 may include a roller 426. The roller 426 may allow the middle link 420 to roll smoothly along a mating edge or surface during engagement, thereby reducing frictional resistance. The middle link 420 may be pivotally connected between the upper link 410 and the lower link 430, and its motion may define the controlled latching and releasing behavior of the four-bar assembly 400.

The lower link 430 may be positioned in direct mechanical contact with the cam 450. The cam 450 includes an outer cam surface configured to bear against a contact surface or follower region formed on the lower link 430. As the cam 450 rotates about its axis, the changing profile of the cam 450 may impart a corresponding displacement to the lower link 430. The resulting angular motion of the lower link 430 may propagate through the four-bar assembly 400, thereby driving the middle link 420 between its extended and retracted positions.

FIG. 4A depicts the four-bar assembly 400 in a capture or engaged configuration. In example embodiments, the cam 450 may be oriented such that the lower link 430 positions the middle link 420 outward, with the roller 426 extending beyond a housing of the four-bar assembly 400 to engage a mating structure (or any other capturable object). The geometry of the four-bar assembly 400 may produce a capture path that aligns the middle link 420 with the target feature or mating structure.

FIG. 4B shows the four-bar assembly 400 in a release configuration. Rotation of the cam 450 in a first direction causes its contact surface to drive the lower link 430 through a defined angular displacement, protracting the middle link 420 outward by forcing the middle link 420 to rotate counterclockwise. This motion withdraws the middle link 420 and roller 426 from the latch surface, thereby releasing the connection between the two interfaces.

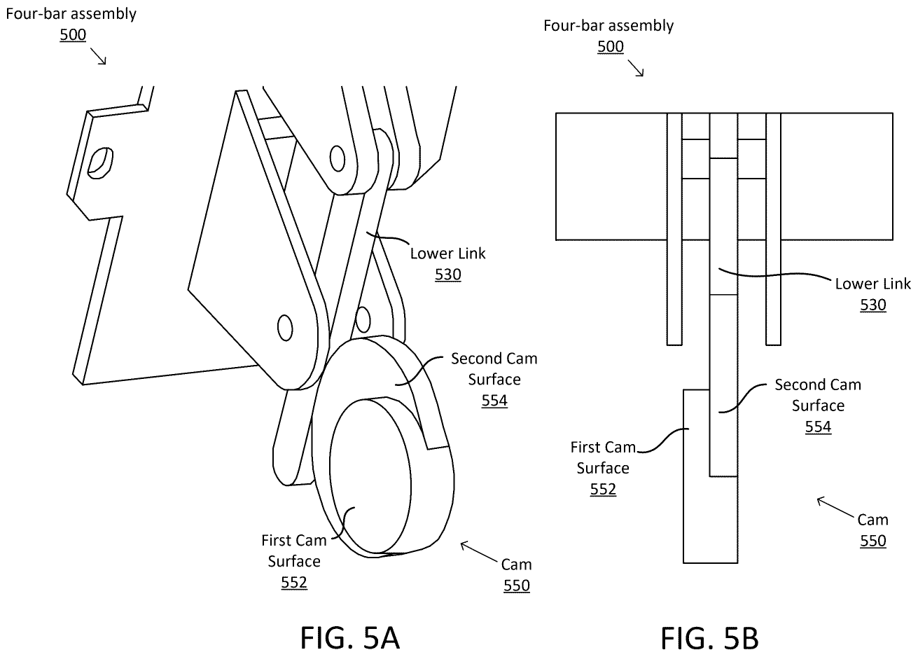

FIGS. 5A and 5B illustrate example embodiments of a four-bar assembly 500, in which a dual-surface cam mechanism provides both standard operational control and a built-in contingency mode. The four-bar assembly 500 may include a lower link 530 that interfaces directly with a cam 550, where the cam 550 incorporates two distinct cam surfaces: a first cam surface 552 and a second cam surface 554. The lower link 530 may be pivotally connected to other elements of the four-bar linkage, such as an upper link and a middle link (not shown for clarity), which collectively define the controlled latching motion of the four-bar assembly 500.

In some example embodiments of the four-bar assembly 500 shown in FIGS. 5A-5B, a torsion spring or other biasing element may be operably coupled to the lower link 430 to provide a predetermined rotational bias. As a nonlimiting example, the spring may be mounted concentrically about the pivot axis of the lower link 530 or anchored between the lower link 530 and the surrounding housing. In example embodiments, the spring may be configured to bias the lower link 530 in either a clockwise or counterclockwise direction, depending on the desired operational behavior. In some example embodiments, the cam 550 may operate in coordination with the spring bias to assist or resist rotation of the lower link 530, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 500 during both manual and automated docking operations.

In normal operation, as illustrated in FIG. 5A and FIG. 5B, the lower link 530 rests against and follows the second cam surface 554. The second cam surface 554 may define a standard operating range (or first operating range) for the lower link 530, corresponding to regular capture and release motions of the four-bar assembly 500. This second cam surface 554 may have a larger radius or broader profile than the first cam surface 552, thereby producing a smooth and moderate range of movement suitable for precise latching or contact operations. The engagement of the lower link 530 with the second cam surface 554 may ensure predictable kinematic behavior, stable latching, and uniform motion transfer through the rest of the linkage.

Under a contingency or overload condition, an external force, biasing spring, or impact event (not illustrated) causes the cam 550 itself to shift position such that the lower link 530 transitions from the second cam surface 554 to the first cam surface 552. The first cam surface 552 may define an alternate motion path (e.g., a second operating range), typically with a different curvature or reduced profile radius, resulting in a larger range of angular displacement for the lower link 530.

When the lower link 530 engages the first cam surface 552, the geometry of the four-bar assembly 500 changes such that the middle link (not shown) is moved into a neutral or deactivated position, effectively taking the middle link out of contact with the mating surface. This transition prevents the four-bar assembly 500 from binding or transmitting excessive load to the docking interface during abnormal conditions. In some example embodiments, the shift between the second cam surface 554 and the first cam surface 552 may be facilitated by an elastic or spring element that biases the lower link 530 toward the first cam surface 552 once the system detects a condition that may require a contingency release.

The dual-surface cam arrangement of FIGS. 5A and 5B may thus provide a mechanical safety valve within the four-bar assembly 500. During standard operation, the four-bar assembly 500 may maintain high positional precision and stability when a fault is detected, potentially due to miscapture or cam rotation failure. The four-bar assembly 500 may automatically reconfigure into a safe geometry that may enable the system to reach a released state. This approach allows the four-bar assembly 500 to maintain redundancy if an unexpected failure were to occur.

In some example embodiments, the cam 550 may also include retention features or guide flanges that control the transition between the first cam surface 552 and the second cam surface 554, ensuring that the lower link 530 moves predictably and does not inadvertently return to the second cam surface 554 until reset. The use of the dual cam surfaces 552 and 554 provides a robust yet mechanically simple means of incorporating redundancy and fault isolation into the four-bar docking architecture.

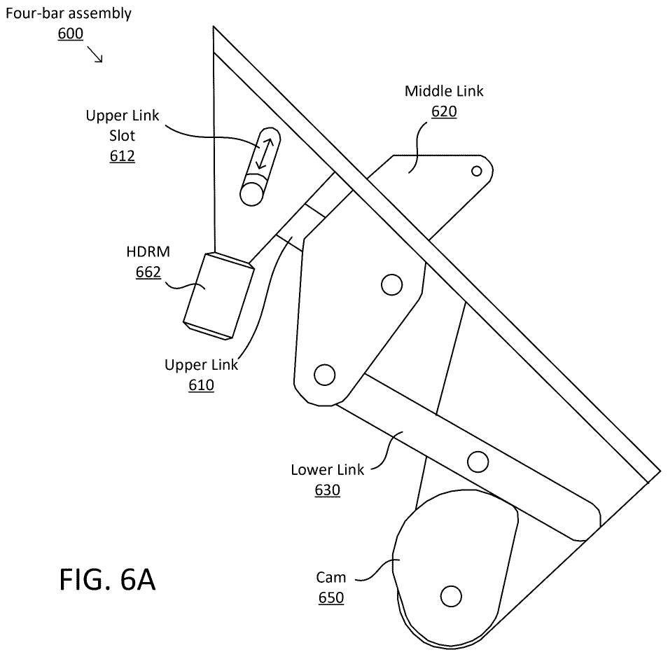

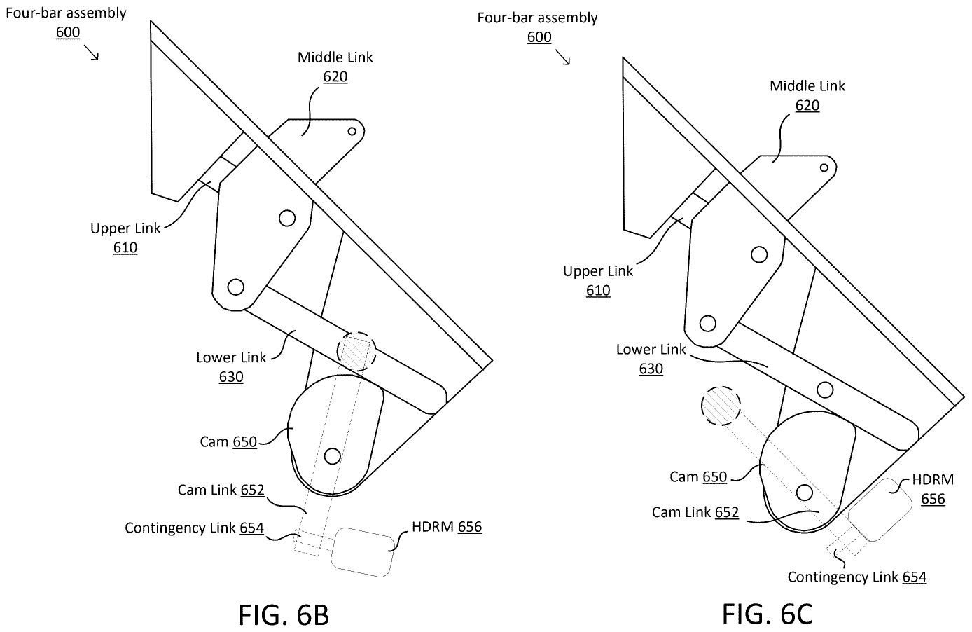

FIG. 6A illustrates example embodiments of a four-bar assembly 600, which incorporates an upper-link slot 612 mechanism controlled by a hold-down and release mechanism (HDRM) 662 to provide contingency motion isolation. In example embodiments, the four-bar assembly 600 may include an upper link 610, a middle link 620, and a lower link 630, all pivotally connected to form a closed four-bar configuration. The lower link 630 may be in mechanical contact with a cam 650, which governs an actuation of the four-bar assembly 600. As the cam 650 rotates about its axis, the profile of the cam 650 drives the lower link 630 through a defined angular displacement, thereby causing the middle link 620 to move in and out of engagement with a mating latch surface, or corresponding surface or object.

The middle link 620 may function as the active latching element of the four-bar assembly 600 and may include a roller feature (not shown for clarity) at its distal end for engaging a capture edge or recess. Under nominal conditions (e.g., non-contingency conditions), rotation of the cam 650 may limit the angular range of motion of the lower link 630 to enable either capture or release, in the same controlled manner described in earlier embodiments discussed elsewhere herein. The four-bar assembly 600 may ensure that the latching motion follows a repeatable trajectory that aligns the middle link 620 with the target latch structure, or corresponding surface or object.

In example embodiments, the upper link 610 may be supported within an elongated upper-link slot 612 formed in the surrounding structure or housing of the four-bar assembly 600. One end of the upper link 610 may be operably attached to the HDRM 662, which normally restrains the upper link 610 in a fixed position along the upper link slot 612. During normal operation, this fixed position maintains the nominal geometry of the movement of the four-bar assembly 600 (i.e., the fixed position keeps the four-bar assembly 600 in a first range of motion), thereby ensuring predictable motion transfer between the lower link 630 and the middle link 620.

Upon activation of the HDRM 662, such as in a contingency, overload, or release event, the upper link 610 may be freed to translate within the upper-link slot 612. This additional degree of freedom allows the upper link 610 to pivot or shift along its axis of travel, effectively collapsing the geometry of the movement of the four-bar assembly 600 (i.e., the fixed position has been broken, and the four-bar assembly 600 may move outside of the first range of motion, e.g., within a second range of motion). As the upper link 610 moves freely, the middle link 620 may be correspondingly displaced into a neutral or non-functional position, taking the active latching element out of commission.

This slot-based contingency mechanism provides a clean mechanical method for disabling the latching function without requiring movement of the cam 650 or lower link 630. Because the upper link 610 may slide or pivot within the upper link slot 612, the four-bar assembly 600 automatically reconfigures into a safe configuration, preventing jamming or unintended engagement even if the cam 650 or lower link 630 remains immovable.

In some example embodiments, the HDRM 662 may include a pyrotechnic, electromagnetic, or shape-memory release element, providing flexible triggering options depending on the application environment. The upper link slot 612 may further include guide surfaces or detents to limit travel and enable the upper link 610 to return to a defined reset position after servicing.

FIG. 6A thus demonstrates an example embodiment in which the contingency motion isolation is achieved through a controlled displacement of the upper link 610 rather than the lower link 630 or cam 650. This configuration preserves the precision and mechanical simplicity of the core linkage while providing an additional, independently actuated path for removing the latching mechanism from commission during abnormal conditions.

FIGS. 6B and 6C illustrate alternative embodiments of the four-bar assembly 600, each providing a distinct arrangement for the HDRM 656-based contingency mechanism. In these example embodiments, the contingency release acts through a cam-link subassembly rather than directly upon the upper link 610, enabling localized decoupling of the drive train while preserving the geometry of the four-bar assembly 600.

The four-bar assembly 600 may include an upper link 610, a middle link 620, and a lower link 630, all interconnected to form a controlled four-bar linkage. A cam 650 may govern the actuation of the four-bar assembly 600, thereby imparting motion to the lower link 630 and thereby controlling the extension and retraction of the middle link 620. The middle link 620 may again include a roller (not shown for clarity) serving as the active latching element.

In FIG. 6B, the HDRM 662 is operably connected to a contingency link 654, which in turn is connected to a cam link 652 mounted at or above the lower link 630. The cam link 652 interfaces mechanically with the cam 650, forming a transmission path between the cam 650 and the lower link 630. Under normal conditions, the HDRM 662 may restrain the contingency link 654 in a fixed position. Upon activation of the HDRM 662, the contingency link 654 releases, permitting the cam link 652 and the cam 650 to pivot freely. This release releases the motion of the cam 650 from the lower link 630, thereby enabling the second range of motion of the lower link 630, which may allow the middle link 620 to release a mating structure.

FIG. 6C shows an alternative configuration in which the cam link 652 is positioned just below the middle link 620, rather than on or above the lower link 630. In example embodiments, the cam link 652 remains functionally connected to the cam 650 but is geometrically located closer to the coupler region of the four-bar assembly 600. The HDRM 662 again actuates a contingency link 654 that secures or releases the cam link 652. When the HDRM 662 is triggered, the contingency link 654 disengages, allowing the cam link 652 to rotate independently or collapse out of its driving position. This motion removes contact between the cam 650 and lower link 630, which in turn may allow the lower link 630 to pivot freely, enabling the middle link 620 to move to a released position.

Both configurations provide mechanically redundant pathways for isolating the latching function without requiring displacement of the links themselves. The choice between the upper (FIG. 6B) or lower (FIG. 6C) cam-link positioning may depend on available space, desired moment arm characteristics, or the required mechanical advantage for the contingency event. In either case, activation of the HDRM 662 ensures that the cam-driven motion path is broken, rendering the four-bar assembly 600 incapable of maintaining capture if the cam 650 is nonfunctional due to a potential fault.

In some example embodiments of the four-bar assembly 600 shown in FIGS. 6A-6C, a torsion spring or other biasing element may be operably coupled to the lower link 630 to provide a predetermined rotational bias. As a nonlimiting example, the spring may be mounted concentrically about the pivot axis of the lower link 630 or anchored between the lower link 630 and the surrounding housing. In example embodiments, the spring may be configured to bias the lower link 630 in either a clockwise or counterclockwise direction, depending on the desired operational behavior. In some example embodiments, the cam 650 may operate in coordination with the spring bias to assist or resist rotation of the lower link 630, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 600 during both manual and automated docking operations.

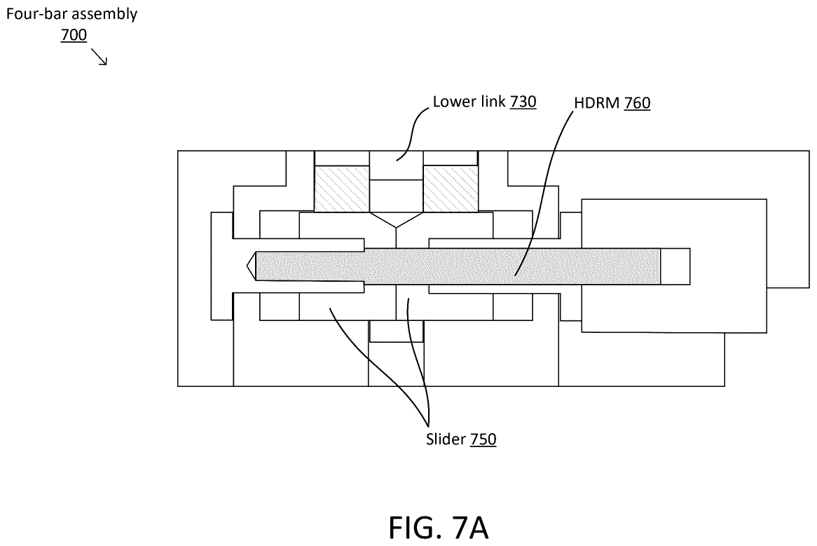

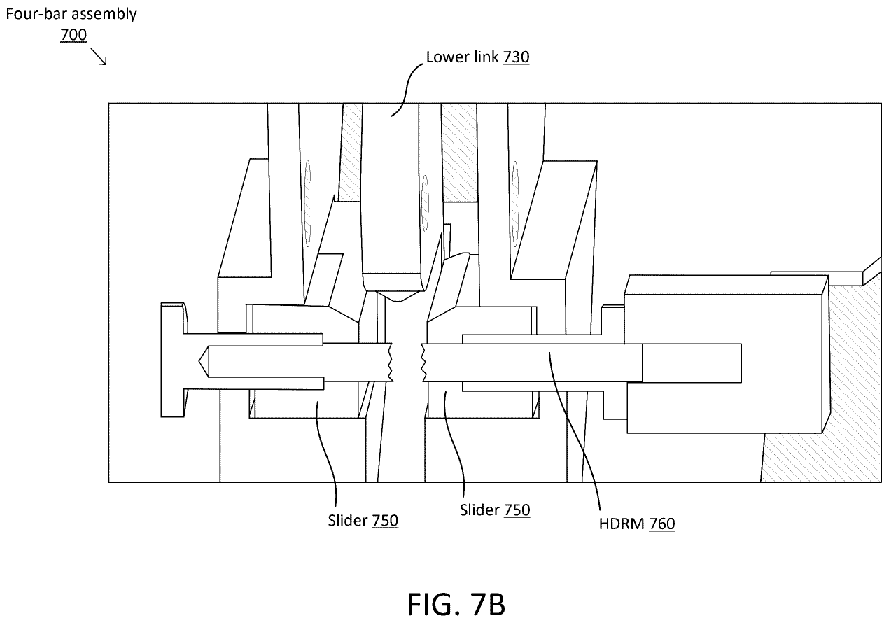

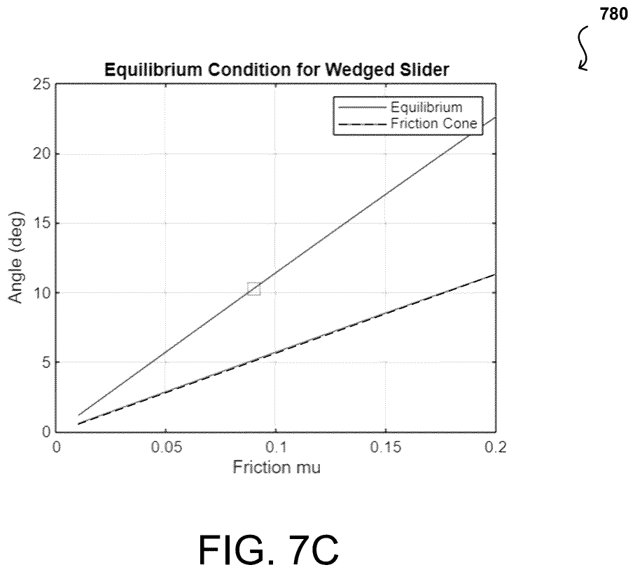

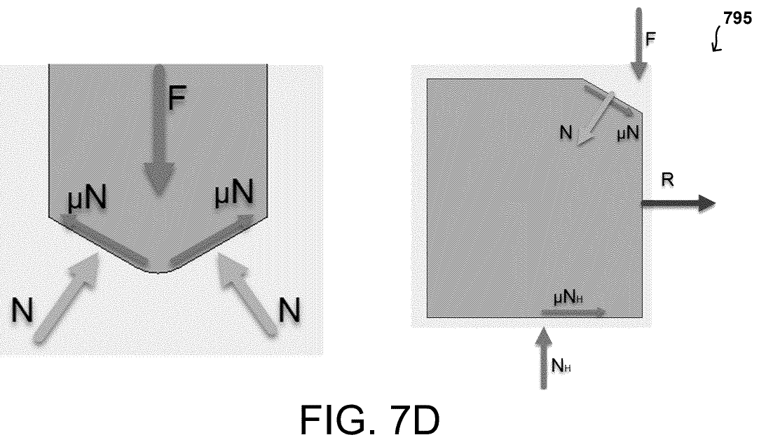

FIGS. 7A and 7B illustrate example embodiments of a four-bar assembly 700, incorporating a split-slider contingency mechanism actuated by an HDRM 760 or equivalent frangible device. The four-bar assembly 700 includes an upper link 710, a middle link (not illustrated), and a lower link 730, each pivotally connected to form a four-bar configuration. The lower link 730 may provide the actuation interface that governs the motion of the middle link and its associated latching elements.

In some example embodiments of the four-bar assembly 700 shown in FIGS. 7A-7B, a torsion spring or other biasing element may be operably coupled to the lower link 730 to provide a predetermined rotational bias. As a nonlimiting example, the spring may be mounted concentrically about the pivot axis of the lower link 730 or anchored between the lower link 730 and the surrounding housing. In example embodiments, the spring may be configured to bias the lower link 730 in either a clockwise or counterclockwise direction, depending on the desired operational behavior. In some example embodiments, the cam slider 750 may operate in coordination with the spring bias to assist or resist rotation of the lower link 730, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 700 during both manual and automated docking operations.

In example embodiments, the lower link 730 may include a wedge-shaped projection positioned to interface with a slider 750. The slider 750 may comprise two complementary halves that meet along a central plane, forming a notch or recess. During normal operation, the two halves of the slider 750 may be held together by the HDRM 760, which may be implemented as a frangible bolt, pyrotechnic clamp, or other suitable releasable fastener. The slider 750 may be mounted within a guide channel or cavity that constrains its motion and maintains alignment with the lower link 730.

FIG. 7A illustrates the four-bar assembly 700 in its normal operating configuration. In this state, the HDRM 760 remains intact, securing the two halves of the slider 750 in fixed relation. The wedge on the lower link 730 bears laterally against the notch of the slider 750, thereby creating a controlled lateral load that resists unwanted play or backlash. This interaction allows the lower link 730 to transmit precise motion through the four-bar assembly 700 while the slider 750 provides mechanical stability and positional constraint.

FIG. 7B shows the four-bar assembly 700 in a contingency or release configuration following activation of the HDRM 760. Upon activation (whether by command, overload detection, or automatic trigger), the HDRM 760 fractures or separates, allowing the two halves of the slider 750 to split apart along the central notch. Once separated, the wedge on the lower link 730 is no longer laterally constrained, enabling the lower link 730 to move freely within its operating envelope. This release action effectively decouples the lower link 730 from its previous constraint path, thereby allowing the entire four-bar assembly 700 to collapse or move into a safe position, which may allow for the separation of the four-bar assembly 700 and mating structure.

The frangible-slider configuration provides a compact and mechanically deterministic method for disabling the latching mechanism under fault conditions. Because the HDRM 760 directly restrains the halves of the slider 750, the transition from secure to released states occurs quickly, without the need for secondary or tertiary actuators or complex control systems. The wedge-and-slider interface also ensures that lateral loads may be evenly distributed across the four-bar assembly 700 during normal operation, improving stiffness and repeatability while maintaining a defined failure mode during contingency activation.

In some example embodiments, the slider 750 may be biased toward the open position by springs or compliant members, ensuring full separation once the HDRM 760 is released. Alternative embodiments may employ mechanically resettable sliders or replaceable frangible elements, allowing the assembly to be re-armed after servicing.

Thus, FIGS. 7A and 7B demonstrate another approach to incorporating redundancy and fault tolerance into the four-bar assembly 700. By combining the stability of a constrained slider 750 during normal operation with the instant mechanical isolation provided by an HDRM-based split mechanism, the design offers a robust solution for high-reliability docking and coupling environments.

FIG. 7C illustrates a plot 780 indicating the relationship between the coefficient of friction and minimum angle of the contact between the slider 750 and the lower link 730 required to ensure the reaction force is able to overcome the frictional force to allow the surfaces to slide.

FIG. 7D illustrates an example contingency release v-groove and the related slider split contingency free-body diagram. As illustrated in the mechanism views 795 of FIG. 7D, a v-groove of the lower link 730 has an angle between the sides of the v that may be optimized. A minimum holding angle may be identified without risk of self-locking. For an angle α:

$$tan ( α ) > \frac{2 μ}{1 - {μ}^{2}}$$

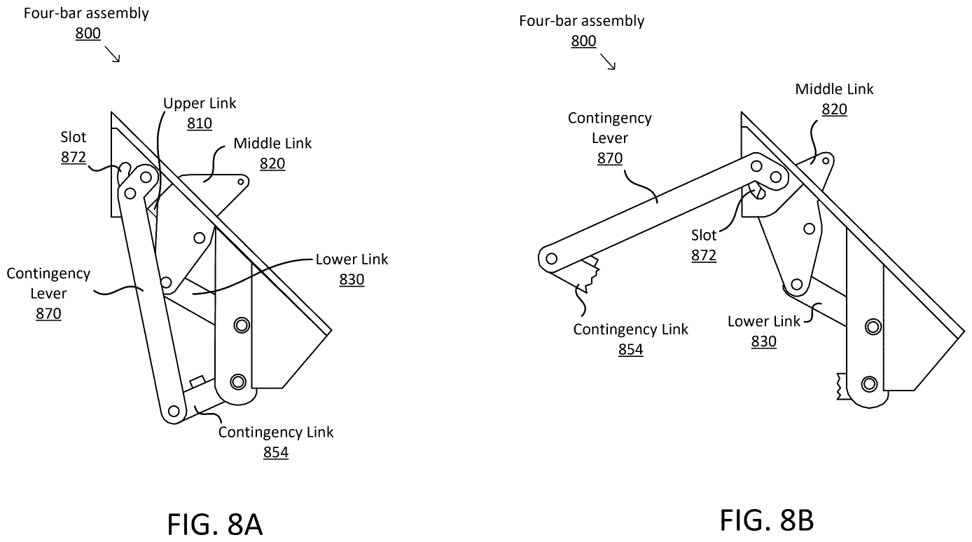

FIGS. 8A and 8B illustrate another embodiment of a four-bar assembly 800, which incorporates a contingency lever-arm mechanism to decouple the motion of the upper link 810 during fault or emergency conditions. The four-bar assembly 800 includes an upper link 810, a middle link 820, and a lower link 830, all pivotally interconnected to form a closed four-bar system. The middle link 820 functions as the active latching member and may include a roller or rounded contact surface (not illustrated) to facilitate reduced friction engagement with a mating latch or docking feature.

A contingency link 854 may connect to the end of a contingency lever 870, which spans between the contingency link 854 and the upper link 810. In example embodiments, one end of the contingency lever 870 is pivotally attached to the contingency link 854, while the opposite end is attached to the upper link 810. The contingency lever 870 may be supported within an elongated slot 872, permitting limited translation or rotation when the contingency system is activated. During normal operation, the contingency link 854 remains intact, holding the contingency lever 870 and upper link 810 in fixed relation. In this state, the four-bar assembly 800 is rigidly maintained, and rotation of the lower link 830 drives the middle link 820 between its capture and release positions.

FIG. 8A illustrates the four-bar assembly 800 in a nominal or engaged condition, with the contingency link 854 intact. The contingency lever 870 may be fixed within the slot 872, thereby constraining the upper link 810 so that the middle link 820 maintains proper alignment for latching operations. As the lower link 830 moves through its normal range, the middle link 820 follows a predictable path for secure docking engagement.

FIG. 8B shows the four-bar assembly 800 in a contingency or released condition, after the contingency link 854 has fractured or separated. Once the contingency link 854 breaks, the contingency lever 870 may be free to translate or pivot about its upper pivot point, thereby allowing the upper link 810 to move independently from its prior fixed position. This freedom of motion collapses the established geometry of the four-bar assembly 800, causing the middle link 820 to shift into a neutral or out-of-commission position. The middle link 820 is thereby withdrawn from any engagement path, preventing interference or jamming with external hardware.

The contingency lever-arm configuration provides a mechanically simple yet effective fault-tolerant option. By routing the contingency release through the contingency lever 870, the design achieves motion isolation at the structural level of the upper link 810 without requiring additional actuators or other displacement of the middle link 820 and lower link 830. The four-bar assembly 800 may thus tolerate structural potential fault scenarios while maintaining overall mechanical integrity and release capability. In some example embodiments, the contingency link 854 may comprise a frangible element, shear pin, or HDRM-based connector, depending on the application environment. The contingency lever 870 may be designed to include a hard stop to define the range of motion for the contingency lever 870.

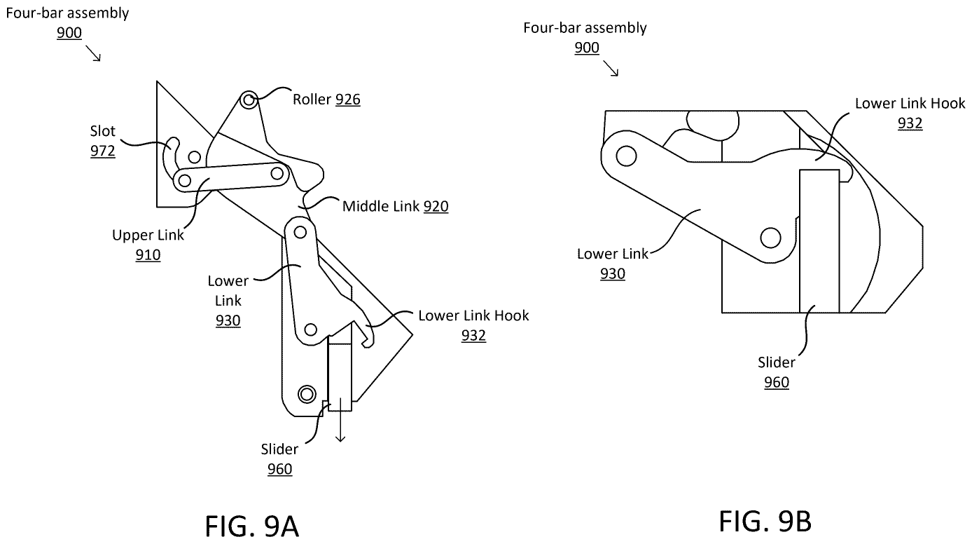

FIGS. 9A and 9B illustrate example embodiments of a four-bar assembly 900 in which a slider 960 serves as an actuation mechanism for controlling the motion of the links in the four-bar assembly 900. The four-bar assembly 900 may include an upper link 910, a middle link 920, and a lower link 930, each pivotally connected to define a closed four-bar configuration. The middle link 920 may function as the active latching element and may include a roller 926 positioned near its distal end for engaging a mating surface or latch feature on an opposing structure. In example embodiments, the four-bar assembly 900 may also include a slot 972 allowing one end of the upper link 910 to have allowance, e.g., allowing the one end of the upper link 910 to translate laterally or in some predetermined track. Movement of one end of the upper link 910 within the slot 972 may further allow the upper link to cause or drive the middle link 920 (as well as the lower link 930) to enter a first range of motion, second range of motion, or other range of motion including, including, without limitation, standby actions, release actions, capture actions, or any actions in between.

In some example embodiments of the four-bar assembly 900 shown in FIGS. 9A-9B, a torsion spring or other biasing element may be operably coupled to the lower link 930 to provide a predetermined rotational bias. As a nonlimiting example, the spring may be mounted concentrically about the pivot axis of the lower link 930 or anchored between the lower link 930 and the surrounding housing. In example embodiments, the spring may be configured to bias the lower link 930 in either a clockwise or counterclockwise direction, depending on the desired operational behavior. In some example embodiments, the slider 960 may operate in coordination with the spring bias to assist or resist rotation of the lower link 930, thereby defining stable intermediate positions such as a standby or retracted position, a ready-to-capture position, and a release position. In other example embodiments, multiple torsion springs or equivalent elastic biasing members (e.g., flexures, leaf springs, or pre-loaded compression elements) may be used to fine-tune the responsiveness of the four-bar assembly 900 during both manual and automated docking operations.

The middle link 920 may serve as the active capture element of the four-bar assembly 900 and may include a roller 926 positioned near a distal end of the middle link 920. The middle link 920 may be connected between the upper link 910 and the lower link 930 such that rotation of the lower link 930 produces a controlled motion of the middle link 920 for docking engagement or release.

The lower link 930 may include a lower link hook 932 formed along its outer surface. The lower link hook 932 may be configured to engage a slider 960, which is received within a slider cavity formed in the adjacent structure or housing. Rather than relying on a rotating cam, the middle link 920 is actuated by the movement of the slider 960. Under normal operating conditions, the slider 960 may remain in the neutral middle position, not shown, where it may contact the lower link 930 at a specific angle within the lower link 930 range of motion. This engagement constrains the lower link 930 within a defined range of motion, ensuring that the middle link 920 maintains its nominal capture trajectory, which may enable successful capture in a docking scenario. Under certain conditions, which may include a high vibrational environment, motion of the four-bar assembly 900 should be limited, the slider 960 may be in an upper position as shown in FIG. 9B, where it is in firm mechanical contact with the lower link hook 932. This engagement constrains the lower link 930 such that it may not pivot in any direction, effectively immobilizing the entire four-bar assembly 900. The interface between the lower link hook 932 and slider 960 provides positional stability and prevents excessive oscillation or backlash.

FIG. 9A shows the four-bar assembly 900 in a release configuration, where the slider 960 is positioned toward the rear of the cavity. In this state, the lower link 930 is rotated clockwise as shown, driven by a spring (not shown), and the middle link 920 is driven through a trajectory that enables release of the striker. In this state, the four-bar assembly 900 operates as intended, allowing unlatching through the rotation of the lower link 930. The purpose of the four-bar assembly 900 is to demonstrate that the lower link hook 932 may lock the entire four-bar assembly 900 in place to prevent all movement, which may be damaging when in a high vibrational environment, such as a launch, re-entry, or landing.

FIG. 9B illustrates the four-bar assembly 900 in an immobilized configuration, with the slider 960 translated forward within the cavity. As the slider 960 advances, the lower link hook 932 rides along the surface of the slider 960, causing the lower link 930 to lose all range of motion (degrees of freedom, etc.). This position prevents any movement within the four-bar assembly 900 to reduce oscillations in a high-vibration environment. Reversing the motion of the slider 960 removes contact between the lower link hook 932 and slider 960, enabling the first range of motion of the lower link 930 required for the latching operation.

In some example embodiments, the slider 960 may be coupled to an electromechanical actuator for controlled deployment. The lower link hook 932 may include hardened contact surfaces or rolling inserts to minimize wear over repeated operations.

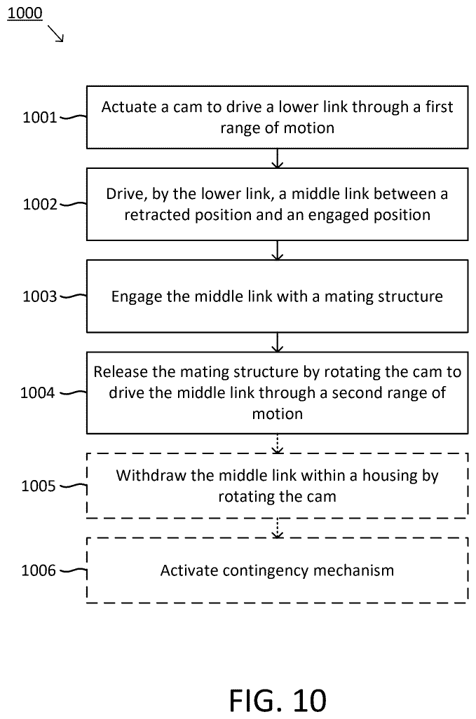

FIG. 10 illustrates a process 1000 of operating a four-bar assembly in accordance with the embodiments described herein. The process 1000 may be executed by any of the assemblies described in connection with FIGS. 1-9, including systems having cam-driven or slider-driven lower links, a middle link as the active latching component, and optional contingency mechanisms. The order of the steps is illustrative, and the steps may be performed sequentially, concurrently, or in a different order depending on the configuration of the four-bar assembly.

The four-bar assembly may actuate 1001 a cam to drive a lower link through a defined range of motion, e.g., a first range of motion. The cam may include one or more cam surfaces that impart a controlled angular displacement to the lower link, establishing the kinematic relationship among the four links of the four-bar assembly. In some example embodiments, the cam is actuated to a position where the lower link rests on a “standby” surface. This surface may impart a controlled limit of angular displacement to the lower link, establishing the kinematic relationship among the four links of the four-bar assembly. This enables the middle link to rest in a standby position and have a first range of motion that allows for capture of the striker of a passive docking system.

The four-bar assembly may be driven 1002 by contact between a mating structure and a middle link through a first motion. The lower link may pivot such that a surface of the lower link may lift off contact with a cam or slider. As the mating structure continues to move into position, the lower link may be driven by a spring to return contact against a cam or slider. This rotation of the lower link may propagate through the four-bar geometry, causing the middle link to move in a predictable path to engage the mating structure. The contact between the lower link and cam or slider limits the rotational range of the lower link to prevent a second motion of the middle link, which would enable release of the mating structure.

The four-bar assembly may engage 1003 the middle link with a latch feature on a mating structure to secure the four-bar assembly to various surfaces or objects, e.g., a docking interface. The middle link may include a roller or curved contact surface that rolls along the mating latch surface during engagement, minimizing friction and ensuring accurate alignment between docking structures.

The four-bar assembly may release 1004 the mating structure by actuating the cam or slider such that a lower link is free to rotate to the clockwise limit, thereby enabling the middle link to travel through a second range of motion, and disengaging the middle link from the latch feature. In example embodiments, for undocking scenarios, the cam or slider is actuated to a position that allows for full motion of the lower link, allowing the middle link to release the striker.

The four-bar assembly may actuate the cam or slider to a position to withdraw 1005 the middle link within the housing of the four-bar assembly. This actuation may place the middle link entirely or partially within the housing, thereby protecting the linkage from external contact or vibrations. In example embodiments, after a mating structure (e.g., an opposing spacecraft) has departed, the cam or slider may continue to actuate, passing through a position where the profile of the cam or slider contacts a feature of the lower link to fully retract the middle link. In other example embodiments, to prepare the system for another latching or docking attempt, the cam is rotated again in the same direction to cause the middle link to reach the “standby” profile in which the middle link may make contact with a mating surface or structure.

The process 1000 may optionally include activating 1006 a contingency mechanism. The contingency mechanism may take various forms, such as an HDRM, a frangible element, a sliding release, or a dual-cam-surface configuration, each configured to selectively enable or isolate the motion of one or more links in the event of a fault, overload, or emergency condition. Activation of the contingency mechanism places the four-bar assembly in a safe, released state while preserving the structural integrity of the surrounding system. In other words, in the event that the cam (or, in other example embodiments, the slider) is unable to actuate due to a potential fault, the contingency release may be activated, thereby allowing the middle-link to move in a manner that allows for the release of the mating structure.

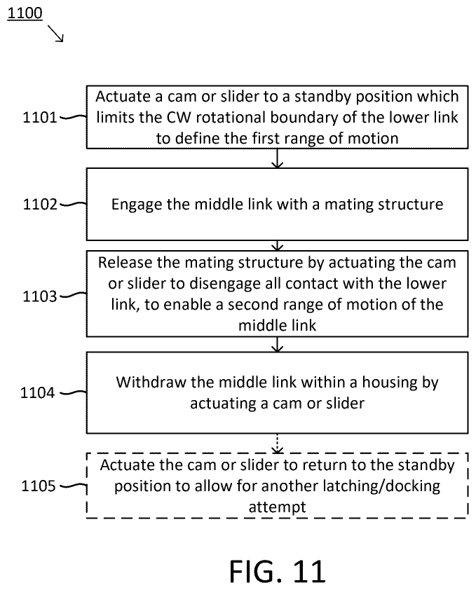

FIG. 11 illustrates a process 1100 representing an example method for controlling the range of motion of a four-bar docking assembly through the actuation of a cam or slider. The process 1100 may be executed by any of the assemblies described herein, including those utilizing a motor-driven slider, a lower link, or a cam-based actuation system. The sequence provides a structured approach for transitioning between standby, engagement, release, and retraction states of the four-bar assembly.

A four-bar assembly may actuate 1101 a cam or slider to a standby position. In this state, the cam or slider may define a first rotational boundary for the lower link, thereby establishing a first range of motion for the four-bar assembly. This initial position constrains the lower link such that the middle link may remain in a neutral or ready orientation, thereby preventing unintended engagement while maintaining the system in a preloaded, controlled configuration.

The four-bar assembly may engage 1102 the middle link with a mating structure. The cam or slider may be actuated to drive the lower link through its defined first range of motion, thereby extending the middle link outward and positioning the roller for contact with the mating surface. In example embodiments, this engagement step results in secure coupling or docking between the four-bar assembly and the opposing structure.

The four-bar assembly may release 1103 the mating structure by further actuating the cam or slider to disengage all contact with the lower link. This action may remove the prior motion constraint, thereby enabling a second range of motion for the middle link. The expanded motion range allows the middle link to withdraw cleanly from the latch interface without resistance, ensuring full release and minimizing risk of interference or partial disengagement.

The four-bar assembly 1104 may fully withdraw the middle link within a housing by continuing to actuate the cam or slider. This motion may drive the four-bar assembly into a stowed or safe configuration, with the middle link and roller entirely retracted within the housing of the four-bar assembly. The step may also serve as a protective mode during periods of inactivity, transport, or system reset.

Finally, the four-bar assembly may optionally actuate 1105 the cam or slider to the standby position, re-establishing the first range of motion for the lower link. This reset may enable the four-bar assembly to prepare for another latching or docking attempt, ensuring consistent starting geometry for repeated operations.

The example embodiments described herein, including the upper link, middle link, lower link, roller, cam, slider, and contingency mechanisms, may be fabricated from a wide variety of materials depending on operational requirements. In aerospace or vacuum environments, the links and cams may be machined from titanium alloys, aluminum, stainless steel, or carbon composites to provide high strength-to-weight ratios and thermal stability. In terrestrial or robotic applications, engineering polymers, reinforced composites, or additive-manufactured structures may be used to reduce cost and enable complex geometries. Bearings, rollers, or contact interfaces may incorporate ceramic, bronze, or PTFE-based coatings to minimize friction and prevent galling under repeated cycling. In some example embodiments, portions of the linkage may be 3D printed as a single monolithic structure or assembled from modular subcomponents.

The geometry and range of motion of each link within the four-bar assembly may vary substantially between embodiments. For example, the relative link lengths and pivot locations may be altered to modify the arc or path of motion of the middle link, enabling longer or shorter engagement travel depending on the target application. The cam profile may be configured for continuous rotation, partial rotation, or oscillatory motion, and the direction of cam rotation may be clockwise, counterclockwise, or bidirectional. Additionally, the slider profile may be configured for varying surface geometries with different set positions along a linear path of travel. The middle link and roller may assume various shapes (hooked, tapered, rounded, or offset) to accommodate different latch geometries or contact angles. Similarly, the contingency mechanisms described herein may be positioned in alternative locations within the linkage chain, provided that they can mechanically isolate or deactivate the middle link when necessary.

Although the example embodiments have been described in the context of spacecraft docking, the same principles may be applied across numerous other mechanical coupling environments. Examples include robotic end-effectors, payload capture systems, underwater submersible docking ports, industrial automation couplers, autonomous vehicle charging or refueling interfaces, and aerospace or marine deployment latches. In any example embodiments, the disclosed four-bar assembly provides a compact, redundant, and kinematically predictable structure for controlled engagement and release. Variations in scale, actuation method, material composition, or mounting configuration may be made without departing from the underlying concepts of using a middle-link driven by a cam or slider-actuated lower link and optionally supported by contingency isolation features.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit disclosure to a specific form or forms disclosed, but on the contrary, the intention is to cover all modifications, alternative constructions, and equivalents falling within the spirit and scope of disclosure, as defined in the appended claims.

Use of terms “a” and “an” and “the” and similar referents in the context of describing disclosed embodiments (especially in the context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein is merely intended to serve as a shorthand method of referring individually to each separate value falling within range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Operations of processes described herein can be performed in any suitable order unless otherwise indicated herein or otherwise clearly contradicted by context. Use of any and all examples, or exemplary language (e.g., “such as”) provided herein, is intended merely to better illuminate embodiments of disclosure and does not pose a limitation on the scope of disclosure unless otherwise claimed. No language in the specification should be construed as indicating any non-claimed element as essential to the practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still cooperate or interact with each other.

What is claimed is:

1. A four-bar assembly comprising:
an upper link;
a middle link operably connected to the upper link, the middle link to engage a mating structure;
a lower link operably connected to the middle link; and
a cam to drive the lower link through a first range of motion and a second range of motion,
wherein the first range of motion of the lower link drives the middle link between a retracted position and an engaged position relative to the mating structure, and
wherein the second range of motion of the lower link drives the middle link between an engaged position and a released position relative to the mating structure.

2. The four-bar assembly of claim 1, wherein the middle link comprises a roller disposed at a distal end of the middle link, the roller to roll along the mating structure and to reduce friction during engagement and release.

3. The four-bar assembly of claim 1, wherein the cam comprises a first cam surface and a second cam surface, the lower link to transition from the second cam surface to the first cam surface in response to a contingency load.

4. The four-bar assembly of claim 1, further comprising a contingency mechanism to selectively deactivate the middle link in response to at least one of a detected fault, overload, or release command.

5. The four-bar assembly of claim 4, wherein the contingency mechanism comprises a hold-down and release mechanism (HDRM) operably coupled to at least one of the upper link, the cam, or a contingency link.

6. The four-bar assembly of claim 4, wherein the contingency mechanism comprises a slider movable within a cavity, the slider to cause the lower link to move within the first range of motion, and to free, when the slider is displaced, the lower link to the second range of motion.

7. The four-bar assembly of claim 4, wherein the contingency mechanism comprises a contingency lever coupled between the upper link and a contingency link, the contingency lever being positioned within a slot such that breakage of the contingency link allows the contingency lever and upper link to move freely.

8. The four-bar assembly of claim 4, wherein the contingency mechanism comprises a split slider comprising two halves held together by a frangible fastener or HDRM, the lower link including a wedge to separate the two halves upon activation.

9. The four-bar assembly of claim 1, wherein the cam is in direct mechanical contact with the lower link.

10. A method comprising:
actuating a cam to drive a lower link, in a four-bar assembly, through a first range of motion;
driving, by the lower link, a middle link from a retracted position to an engaged position;
engaging the middle link with a mating structure; and
releasing the middle link from the mating structure by actuating the cam to drive the middle link through a second range of motion.

11. The method of claim 10, further comprising rolling a roller disposed at a distal end of the middle link.

12. The method of claim 10, further comprising, in response to a contingency event, activating a hold-down and release mechanism (HDRM) to decouple at least one link of the four-bar assembly.

13. The method of claim 12, wherein activating the HDRM causes an upper link to translate within a slot.

14. The method of claim 12, wherein activating the HDRM causes a cam link to disengage from the cam and the lower link to move in a third range of motion.

15. The method of claim 10, further comprising sliding a slider along a cavity to disengage a lower link hook, and permitting the lower link to rotate.

16. A four-bar docking assembly, comprising:
an upper link;
a middle link to latch onto a mating structure;
a lower link; and
a slider to drive the lower link through a first range of motion and a second range of motion,
wherein the first range of motion of the lower link drives the middle link between a retracted position and an engaged position relative to the mating structure, and
wherein the second range of motion of the lower link drives the middle link between an engaged position and a released position relative to the mating structure.

17. The four-bar docking assembly of claim 16, further comprising a contingency element to disable the middle link under one or more contingency conditions, wherein the contingency element comprises a dual-surface cam comprising a first cam surface and a second cam surface to produce two or more ranges of motion for the lower link.

18. The four-bar docking assembly of claim 16, wherein the lower link comprises a spring to bias the lower link clockwise against the slider.

19. The four-bar docking assembly of claim 17, wherein the contingency element comprises a contingency lever and frangible connector, the contingency lever to move freely within a slot upon breakage of the frangible connector.

20. The four-bar docking assembly of claim 17, wherein the contingency element comprises a split slider restrained by a hold-down and release mechanism (HDRM), the split slider to separate upon activation and allow free movement of the lower link.
